(19) United States
(12) Patent Application Publication
(10) Pub. No.: US 2026/0268785 A1
(43) Pub. Date: Sep. 10, 2026

(54) DEVICES, SYSTEMS AND METHODS FOR WORKFLOW TUTORIAL GENERATION

(71) Applicant: Voxware, Inc., Waltham, MA (US)

(72) Inventor: Jason Barrett, Sowell, NJ (US)

(21) Appl. No.: 19/167,332

(22) PCT Filed: Mar. 20, 2024
(86) PCT No.: PCT/US2024/020735

§ 371 Date: Sep. 19, 2025

Related U.S. Application Data
(60) Provisional application No. 63/453,310, filed on Mar. 20, 2023.

(51) Int. Cl. G09B 5/06

(52) U.S. Cl. CPC G09B 5/06

(57) ABSTRACT

An apparatus, method, and system for delivering tutorial elements to a user in response to real time events, the apparatus comprising an output device, a processor, and a memory having stored instructions which cause the processor to receive real-time event data in the environment, enqueue the event data in a trigger events queue, transmit the event data to an initiation module, invoke a rules engine having a plurality of logical rules relating to a real time event triggering delivery of a tutorial element, create a rules engine output, the rules engine output including data relating to an identified tutorial element to deliver in accordance with a rule relating to the event data, enqueue the rules engine output in a tutorial elements output queue, and upon the rules engine output reaching the top of the tutorial elements output queue, output the identified tutorial element via the output device.

### CROSS REFERENCE TO RELATED APPLICATIONS

This application claims the benefit of U.S. Provisional Patent Application No. 63/453,310, entitled “Workflow Tutorial Device,” filed Mar. 20, 2023, the entirety of which is incorporated by reference.

### TECHNICAL FIELD

The present disclosure relates generally to creation and presentation of audiovisual content, and more specifically to devices, systems and methods for the creation and presentation of audiovisual tutorial content relating to physical workflow training.

### BACKGROUND

In some organizations, workers are responsible for processing manual tasks in fixed, repeatable workflows, with high throughput requirements, using mobile computing devices and peripherals that are specialized to the tasks. For example, these types of manual workflows may be found in the logistics and supply chain industry, in warehouse and retail environments, as well as others. Workflows of this type may be best learned via a hands-on process, within the work environment itself, rather than in a traditional training environment such as at a desk. However, training content, in the form of audiovisual content, text, images, video, and the like may be useful in the process of training workers on the workflow. A device that can deliver audiovisual training content relating to a workflow, within the environment in which the workflow will ultimately need to be performed, and using the same devices and peripherals with which the users will perform the work, is therefore desirable.

In an environment where training will occur simultaneous with the worker performing the tasks, it would be desirable for the worker's interaction with the training device, e.g. to advance to the next point of the training, or to request repetition, to be accomplished without the use of the worker's hands.

### SUMMARY

One general aspect includes an apparatus for delivering tutorial elements to a user in response to real time events in an environment of the user. The apparatus also includes an output device. The apparatus also includes a processor. The apparatus also includes a memory, the memory having stored thereon computer executable instructions which, when executed by the processor, cause the processor to: receive event data relating to a real time event in the environment, enqueue the event data in a trigger events queue, transmit the event data to an initiation module, invoke a rules engine, the rules engine having a plurality of logical rules relating to a real time event triggering delivery of a tutorial element, create a rules engine output, using the rules engine, the rules engine output including data relating to an identified tutorial element to deliver in accordance with a rule relating to the event data, enqueue the rules engine output in a tutorial elements output queue, and upon the rules engine output reaching the top of the tutorial elements output queue, output the identified tutorial element via the output device. Other embodiments of this aspect include corresponding computer systems, apparatus, and computer programs recorded on one or more computer storage devices, each configured to perform the actions of the methods.

Implementations may include one or more of the following features. The apparatus where the output device is at least one of: an audio output device, display, virtual reality device, or radio frequency scanning device. The rules engine output is further based on user data relating to the user of the apparatus at the time of the real time event. The user data includes user experience data relating to a level of experience of the user with respect to one of the event and the identified tutorial element. The real time event is received by the apparatus via input from the user to an input device. The real time event is received via observation of the environment by the apparatus without direct input from the user. The apparatus may include an augmented reality viewer configured to observe the environment of the user to register events. Implementations of the described techniques may include hardware, a method or process, or computer software on a computer-accessible medium.

One general aspect includes a system for use by a developer in developing tutorial elements for delivery to a user device in response to real time events measured by the user device. The system also includes a processor. The system also includes a memory, the memory having stored thereon computer executable instructions which, when executed by the processor, cause the processor to: generate and display a first user interface for creation and editing of a set of tutorial elements, where the tutorial elements include at least one of text, audio, and video, generate and display a second user interface for designing a tutorial element for a class of user device form factor(s) chosen by the developer, generate and display a third user interface for the developer to create a rule, the rule including logical conditions relating to the real time events to trigger delivery of the set of tutorial elements, and store the rule and the tutorial element. Other embodiments of this aspect include corresponding computer systems, apparatus, and computer programs recorded on one or more computer storage devices, each configured to perform the actions of the methods.

Implementations may include one or more of the following features. The system where the rule is based on user data relating to the user of the user device at the time of the real time events. The user data includes user experience data relating to a level of experience of the user with respect to one of the real time events and the tutorial element. Implementations of the described techniques may include hardware, a method or process, or computer software on a computer-accessible medium.

One general aspect includes a method of delivering tutorial elements to a user in response to real time events in an environment of the user. The method also includes receiving event data relating to a real time event in the environment. The method also includes enqueueing the event data in a trigger events queue. The method also includes transmitting the event data to an initiation module. The method also includes invoking a rules engine, the rules engine having a plurality of logical rules relating to a real time event triggering delivery of a tutorial element. The method also includes creating a rules engine output, using the rules engine, the rules engine output including data relating to an identified tutorial element to deliver in accordance with a rule relating to the event data. The method also includes enqueueing the rules engine output in a tutorial elements output queue. The method also includes upon the rules engine output reaching the top of the tutorial elements output queue, outputting the identified tutorial element via the output device. Other embodiments of this aspect include corresponding computer systems, apparatus, and computer programs recorded on one or more computer storage devices, each configured to perform the actions of the methods.

Implementations may include one or more of the following features. The method where the output device is at least one of: an audio output device, display, virtual reality device, or radio frequency scanning device. The rules engine output is further based on user data relating to the user of the apparatus at the time of the real time event. The user data includes user experience data relating to a level of experience of the user with respect to one of the event and the identified tutorial element. The real time event is received via input from the user to an input device. The real time event is received via observation of the environment without direct input from the user. The method may include an augmented reality viewer configured to observe the environment of the user to register events. Implementations of the described techniques may include hardware, a method or process, or computer software on a computer-accessible medium.

One general aspect includes An apparatus for workflow navigation, for use in a system for delivering workflow tutorials to a user device using one or more modalities including at least one of speech recognition and synthesis, still and video visual displays, virtual reality, and radio frequency scanning, the apparatus comprising a computer having a processor and a memory, the memory having stored thereon: tutorial element data representing a plurality of tutorial elements for a particular tutorial workflow of a plurality of tutorial workflows. The tutorial element data also includes tutorial rules data representing a plurality of rules for presentation of the plurality of tutorial elements for a particular tutorial workflow of a plurality of tutorial workflows. The data also includes computer executable instructions which, when executed by the processor, cause the processor to run a workflow navigation module to: determine whether, in accordance with at least a first of the plurality of tutorial rules, at least a first of the plurality of tutorial elements should be output to an output device coupled to the user device; in response to a determination that at least one of the plurality of tutorial elements should be output, output the first of the plurality of tutorial elements using a predetermined modality, on the output device, in accordance with at least one of the plurality of tutorial rules; receive input from the user device; and output a second of the plurality of tutorial elements, on the output device, in response to the input and in accordance with at least a second of the plurality of tutorial rules. Other embodiments of this aspect include corresponding computer systems, apparatus, and computer programs recorded on one or more computer storage devices, each configured to perform the actions of the methods.

Implementations may include one or more of the following features. The apparatus where the output device is at least one of: an audio output device, display, virtual reality device, and radio frequency scanning device. The input from the user device is received, at the user device, via tactile interaction from the user. The input from the user device is received, at the user device, via a barcode scan of a coded input. The tutorial elements are presented automatically upon login for a configurable number of logins or on-demand based on the tutorial rules. The input from the user device is received, at the user device, via voice recognition. At least a portion of the plurality of tutorial elements contains an audio element. The apparatus where the memory further contains user data relating to a plurality of users who may log in to the user device. At least one of the plurality of rules relates to an identity of one of the plurality of users, who is logged in to the user device, and where the workflow navigation module is further configured to receive an identity input relating to the identity of the one of the plurality of users who is logged in to the user device. The workflow navigation module is configured to determine, based on the identity of the user and any particular attributes of the user, whether and how to display any of the plurality of tutorial elements, including a preferred language of the user or particular modality, or referring to the user by name or preferred appellation. The user data contains user preference data relating to a manner in which the plurality of tutorial elements will be output. The input may include a navigation input from the group may include of: a forward user input indicating a desire to move to a next tutorial element, a backward user input indicating a desire to move to a previous tutorial element, and a completed user input indicating a desire to complete the workflow tutorial. The memory further contains computer executable instructions which, when executed by the processor, cause the processor to run a workflow creation module, where the workflow creation module is configured to create, based on workflow creation input, the plurality of tutorial elements, and where the plurality of tutorial elements may include audiovisual content representative of a process of physical workflow. The workflow creation module is configured to create, based on rules input, the plurality of tutorial rules. Implementations of the described techniques may include hardware, a method or process, or computer software on a computer-accessible medium.

One general aspect includes a system for delivering workflow tutorials to a user device using one or more modalities including at least one of speech recognition and synthesis. The system also includes tutorial element data representing a plurality of tutorial elements for a particular tutorial workflow of a plurality of tutorial workflows, where the tutorial element data may include associations to at least one of text, audio, video, and virtual reality. The system also includes tutorial rules data representing a plurality of rules for presentation of the plurality of tutorial elements for a particular tutorial workflow of a plurality of tutorial workflows. The system also includes computer executable instructions which, when executed by the processor, cause the processor to run a workflow navigation module. The system also includes where the workflow navigation module is configured to: determine whether, in accordance with at least a first of the plurality of tutorial rules, at least a first of the plurality of tutorial elements should be output to an output device coupled to the user device; in response to a determination that at least one of the plurality of tutorial elements should be output, output the first of the plurality of tutorial elements using a predetermined modality, on the output device, in accordance with at least one of the plurality of tutorial rules; receive input from the user device; and output a second of the plurality of tutorial elements, on the output device, in response to the input and in accordance with at least a second of the plurality of tutorial rules. Other embodiments of this aspect include corresponding computer systems, apparatus, and computer programs recorded on one or more computer storage devices, each configured to perform the actions of the methods.

Implementations may include one or more of the following features. The system where the output device is at least one of: an audio output device, display, virtual reality, and radio frequency scanning. The input from the user device is received, at the user device, via tactile interaction from the user. The input from the user device is received, at the user device, via a barcode scan of a coded input. The tutorial elements are presented automatically upon login for a configurable number of logins or on-demand based on the tutorial rules. The input from the user device is received, at the user device, via voice recognition. At least a portion of the plurality of tutorial elements contains an audio element. The system where the memory further contains user data relating to a plurality of users who may log in to the user device. At least one of the plurality of rules relates to an identity of one of the plurality of users, who is logged in to the user device, and where the workflow navigation module is further configured to receive an identity input relating to the identity of the one of the plurality of users who is logged in to the user device. The workflow navigation module is configured to determine, based on the identity of the user and any particular attributes of the user, whether and how to display any of the plurality of tutorial elements, including a preferred language of the user or particular modality, or referring to the user by name or preferred appellation. The user data contains user preference data relating to a manner in which the plurality of tutorial elements will be output. The input may include a navigation input from the group may include of: a forward user input indicating a desire to move to a next tutorial element, a backward user input indicating a desire to move to a previous tutorial element, and a completed user input indicating a desire to complete the workflow tutorial. The memory further contains computer executable instructions which, when executed by the processor, cause the processor to run a workflow creation module, where the workflow creation module is configured to create, based on workflow creation input, the plurality of tutorial elements, and where the plurality of tutorial elements may include audiovisual content representative of a process of physical workflow. The workflow creation module is configured to create, based on rules input, the plurality of tutorial rules. Implementations of the described techniques may include hardware, a method or process, or computer software on a computer-accessible medium.

One general aspect includes a method of delivering workflow tutorials to a user device using one or more modalities including at least one of speech recognition and synthesis. The method also includes tutorial element data representing a plurality of tutorial elements for a particular tutorial workflow of a plurality of tutorial workflows, where the tutorial element data may include associations to at least one of text, audio, video, and virtual reality. The method also includes tutorial rules data representing a plurality of rules for presentation of the plurality of tutorial elements for a particular tutorial workflow of a plurality of tutorial workflows. The method also includes the method may include the steps of: determining whether, in accordance with at least a first of the plurality of tutorial rules, at least a first of the plurality of tutorial elements should be output to an output device coupled to the user device; in response to a determination that at least one of the plurality of tutorial elements should be output, outputting the first of the plurality of tutorial elements using a predetermined modality, on the output device, in accordance with at least one of the plurality of tutorial rules; receiving input from the user device; and outputting a second of the plurality of tutorial elements, on the output device, in response to the input and in accordance with at least a second of the plurality of tutorial rules. Other embodiments of this aspect include corresponding computer systems, apparatus, and computer programs recorded on one or more computer storage devices, each configured to perform the actions of the methods.

Implementations may include one or more of the following features. The method where the output device is at least one of: an audio output device, display, virtual reality, and radio frequency scanning. The input from the user device is received, at the user device, via tactile interaction from the user. The input from the user device is received, at the user device, via a barcode scan of a coded input. The tutorial elements are presented automatically upon login for a configurable number of logins or on-demand based on the tutorial rules. The input from the user device is received, at the user device, via voice recognition. At least a portion of the plurality of tutorial elements contains an audio element. The method where the memory further contains user data relating to a plurality of users who may log in to the user device. At least one of the plurality of rules relates to an identity of one of the plurality of users, who is logged in to the user device, the method may include the step of receiving an identity input relating to the identity of the one of the plurality of users who is logged in to the user device. The method may include the step of determining, based on the identity of the user and any particular attributes of the user, whether and how to display any of the plurality of tutorial elements, including a preferred language of the user or particular modality, or referring to the user by name or preferred appellation. The user data contains user preference data relating to a manner in which the plurality of tutorial elements will be output. The input may include a navigation input from the group may include of: a forward user input indicating a desire to move to a next tutorial element, a backward user input indicating a desire to move to a previous tutorial element, and a completed user input indicating a desire to complete the workflow tutorial. The plurality of tutorial elements may include audiovisual content representative of a process of physical workflow. The workflow creation module is configured to create, based on rules input, the plurality of tutorial rules. Implementations of the described techniques may include hardware, a method or process, or computer software on a computer-accessible medium.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 is a block diagram of a workflow training system in accordance with one aspect of the present disclosure.

FIG. 2 is a block diagram of exemplary user interactions with the workflow training system in accordance with one aspect of the present disclosure.

FIG. 3 is an exemplary user interface for a user receiving training using a workflow training system in accordance with one aspect of the present disclosure.

FIGS. 4A through 4C are exemplary set of user interface elements, in accordance with one aspect of the present disclosure.

FIG. 5 is a system diagram for an initiation module in accordance with one aspect of the present disclosure.

FIG. 6 is a a block diagram of a workflow tutorial device, in accordance with one aspect of the present disclosure.

FIG. 7 is a flow diagram of a method in accordance with one aspect of the present disclosure.

### DESCRIPTION OF IMPLEMENTATIONS

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first electronic device could be termed a second electronic device, and, similarly, a second electronic device could be termed a first electronic device, without departing from the scope of the various described implementations. The first electronic device and the second electronic device are both electronic devices, but they are not necessarily the same electronic device.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Organizations whose business depends on efficient completion of such manual workflows, for example, organizations doing business in the logistics and supply chain industry, often experience high employee turnover and seasonal or special surges in demand for product and therefore labor. It is essential for these organizations that new or temporary employees reach optimal productivity quickly.

Organizations may require completion of various different manual workflows of varying difficulty or complexity. Some workflows may require the use of specialized equipment while others may not. It is essential for these organizations to be able to ‘graduate’ employees from simpler workflows to more difficult workflows that may require the employee to learn the use of new software or equipment. It is also essential for these organizations to sometimes use employees to ‘fill in’ on workflows that those employees may not be highly familiar with. For example, a warehouse may have a picker fill in at the pack station due to an absence.

Workers in hands on work environments, such as warehouses, may be directed through workflows, for training purposes, by a computer system, which may use any of several different modalities to communicate instructions and other information to the worker, and receive requests, confirmations and other input from the worker. Modalities that may be used in training content may include, but are not limited to, text, e.g. rich text such as text formatted with HTML, audio content e.g. via text to speech, audio user input, e.g. via speech recognition, visual (screens), RF scanning, and/or virtual reality.

In some embodiments, a worker may interact with the training system via a user device, such as a mobile terminal and/or other electronic equipment, which may be located on or proximate to the worker's person, and which the worker may use for communication, e.g. two way communication, with the computer system. Such a user device may be a smartphone or a smartphone-style device, a set of smart glasses, a virtual reality headset, or any other form factor which may render some or all of the tutorial elements discussed herein. In some embodiments the user device may be coupled to an output device, such as a virtual reality headset. In other embodiments, the user device and the output device may be part of the same device, such as a standalone virtual reality headset or a smartphone with a screen. The user device may also either contain, or be coupled to, a user input device, such as a microphone, a touch screen, a keyboard, a mouse, or the like.

In some embodiments, the user device may interact with a separate device, e.g. a server or other computer based device, where training content, as discussed in more detail below, may be located. In an alternate architecture, the training content, the rules for running it, and other content and software required to present the training content to the worker in the work environment, may be contained mostly or entirely within to the user device, e.g. contained within one or more memories within the user device and, e.g., executed by a processor contained within the user device.

It is desirable that the computer system be able to direct the worker as quickly and efficiently as possible, and for the worker to learn to communicate with the computer system in a short span of time. In steady-state usage of the system, the worker should require only short, fast instructions, and should be able to respond immediately and accurately. For best productivity, the system will not provide detailed instructions to the worker.

A tutorial system as disclosed herein is designed to provide instructions, e.g. training, relating to workflow execution, or relating to changes to workflow execution, that can be provided within the work environment, so that workers may interact with the training content and practice the workflow, at the same or substantially the same time. The tutorial system may provide instructions in the form of a visual display of words and images, an audio stream, a virtual reality experience, or some combination of the above. The tutorial system may in some embodiments provide these instructions in more than one language, which may in some embodiments be selected by the worker via user input.

As used herein, “display” may mean, include and refer to different output devices and/or the use of same. Persons having skill in the art may recognize that not all output devices may be or include a visual display. Some may include visual display elements, while others may be audio only, text only, or feature other methods of outputting content, information, data, or the like, to a user.

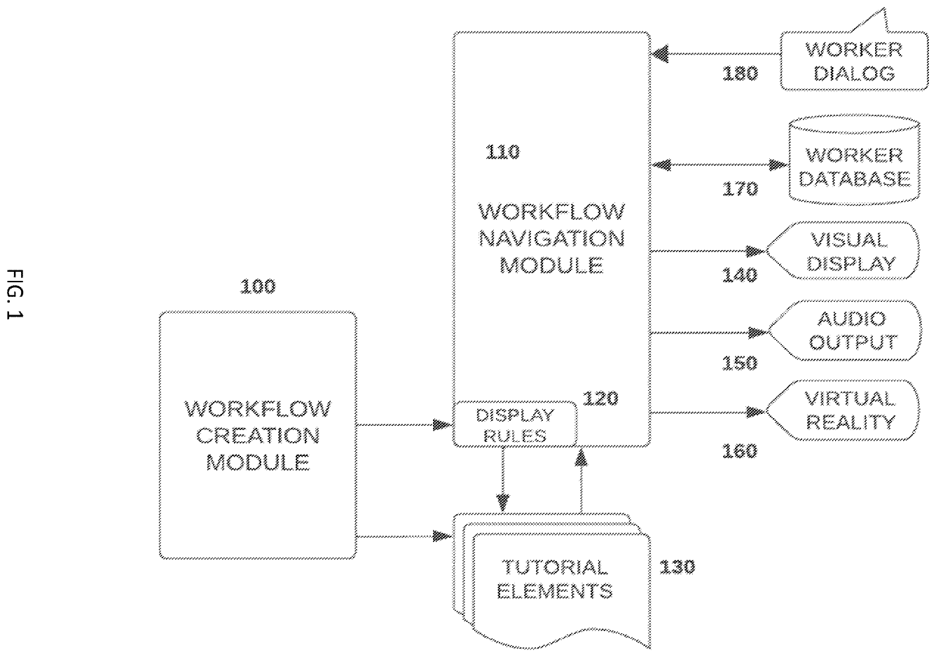

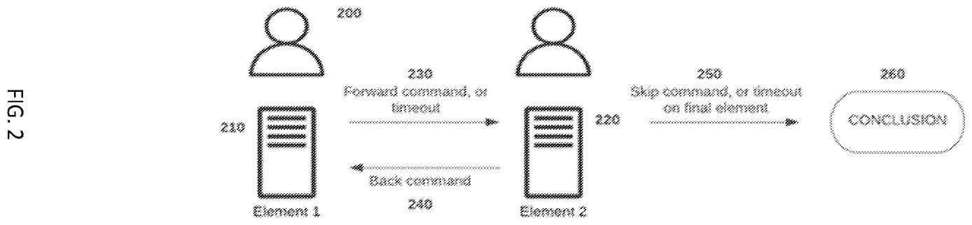

Turning now to FIG. 1, an exemplary system block diagram is shown. FIG. 1 shows the computing modules of the system and the interaction between them. FIG. 1 also shows the exemplary artifacts that comprise the tutorial content, and exemplary output modalities according to at least one embodiment of the invention. The system of FIG. 1 may include computing modules, such as the workflow creation module 100 and workflow navigation module 110. Management, e.g. an “administrator”, may use workflow creation module 100 to create a plurality of tutorial elements 130 and to make the tutorial elements 130 available to workers in a predefined order defined by an administrator. In some embodiments, tutorial elements may refer to graphical user interfaces or visual output screens for display to a worker. Workflow creation module 100 may also provide a mechanism for the administrator to select from a set of previously created tutorial elements 130, and to specify the sequence in which the tutorial elements 130 will be presented to the worker, e.g. worker 200 of FIG. 2 as discussed below.

Workflow creation module 100 may also provide a mechanism for the administrator to choose the point or points in the execution of the workflow in which the tutorial will be either (a) presented to the worker by default, or (b) available for the worker if the worker chooses to experience the tutorial. The mechanism may specify that there are points in the execution of the workflow where the tutorial is not available. The mechanism may also allow the administrator to set a minimum number of times which the worker must, or may, experience the tutorial. This mechanism may be accomplished in accordance with display rules 120, which may relate to the consumption of the workflow training content. Display rules 120 may specify aspects of the worker's experience with the tutorial, which may including the number of times the worker may, or must, view the tutorial and the points in the workflow, e.g. points in time or steps in a workflow process, where the tutorial content will be available.

In one example, the workflow creation module 100 may allow the administrator to mandate the tutorial for each worker immediately after logging in to the workflow application and before undertaking any work. In another example, the workflow creation module may allow the administrator to permit the worker to request the tutorial with a voice command from a ‘special menu’ of options available at points in the workflow where the worker is between atomic units of work.

Workflow navigation module 110 may be used at run time to display tutorial elements 130 that had been created using workflow creation module 100. Workflow navigation module 110 may display certain of tutorial elements 130 in accordance with display rules 120, which may specify, e.g., the order of display of the tutorial elements 130, and/or how many times a particular worker may be required to view a particular one of, or subset of, tutorial elements 130. Display rules 120 and/or tutorial elements 130 may also include instructions, e.g. code, for response to worker input to navigate through the training.

In some embodiments, workflow creation module 100 and the workflow navigation module 110 may be implemented in software that may run as desktop applications, web applications, or in any other mode of operation. The workflow navigation module 110 may include multiple software components that interact on the same computer system, or across computer systems via local area network (LAN) or wide area network (WAN), or via Internet access. The workflow creation module 100 and the workflow navigation module 110 may be co-located and executable on a mobile terminal with the visual display 140 and the audio output 150 or may be located and executable on a separate computer system in contact with the worker's mobile terminal over a local area network (LAN) or wide area network (WAN) or via Internet access.

Display rules 120 are accessible to workflow navigation module 110 and may be established in part or whole by workflow creation module 100, and by the interaction of a training creator, e.g. an administrator, with workflow creation module 100. In one example of a display rule 120, the system may direct that the tutorial is displayed to the worker immediately upon login, a total of 3 times. In another example of a display rule 120, the system may direct that the worker may, upon completing a discrete task in the workflow, provide user input to the system, e.g. in the form of a voice command, for the purposes of requesting to experience the tutorial, e.g. by speaking a phrase such as ‘run tutorial’. In another example of a display rule 120, the system may speak a command to the worker at the outset of the tutorial to alert the worker that the tutorial is beginning and to direct the worker's attention to an output device such as a visual display.

In some embodiments, tutorial elements 130 may be a set of artifacts that embody elements of the tutorial. Artifacts may include rich text, audio, or visual elements to guide the worker through the training, and may also include a virtual or augmented reality environment where the user can access the training while also experiencing the work environment and performing the tasks directed by the tutorial element 130. Workflow navigation module 110 may load tutorial elements 130 and present them to the worker at the appropriate point, e.g. in time, in the tutorial experience.

Tutorial elements may include visual displays, including but not limited to HTML-based screens to be displayed in a web-style viewer, and which may include text, images, tables, any combination of the above, or any form of visual stimulus. Tutorial elements 130 may also include audio or video components, which may be stored or instantiated in known file formats such as WAV, MP4, MOV, or any other audio or video format. These components may be standalone or embedded or otherwise combined with the visual displays mentioned above, and the presentation of these elements as part of the larger training element 130 may be created by an administrator using workflow creation module 100. Tutorial elements 130 may also include virtual reality displays and experiences. These components may be standalone or embedded or otherwise combined with the visual displays mentioned above.

Tutorial elements 130 may also include embedded interactive sample workflow components where the worker may respond to prompts and stimuli presented in the sample workflow as though the stimuli were real, e.g. in a virtual or augmented reality. These components may be standalone or embedded otherwise combined with the visual displays mentioned above.

In one example, where the worker will be interacting with a voice-directed system via speech, the tutorial system may include a scripted sample dialog between the system and a worker. In one example, a voice recognition dialog may embody a small sample of a speech-enabled workflow, where a prompt, e.g. an audio prompt, may direct the worker to take an action in the workflow. The worker may then respond by providing user input, e.g. in the form of speaking a response, which may mimic or resemble actions the worker may take, or things the worker may need to say, in the actual workflow in the work environment. The sample dialog in this example may give the worker feedback via visual display, audio, virtual reality or another modality, based on the worker's response to the sample prompt.

Workflow navigation module 110 may be communicatively coupled to a visual display 140, an audio output 150, and/or a virtual reality display 160. These output devices may be part of or maybe connected or otherwise coupled to, the user device and/or other equipment used by the worker. The user device may, in some embodiments, be a mobile computer with a screen display capable of showing still and/or video images, and audio speakers. In that configuration, workflow navigation module 110 may direct output to visual display 140 and audio output 150, and may use resources provided to it by the operating system of the user device to provide the output to the worker.

Workflow navigation module 110 may include one or more components for the worker to interact with the tutorial. The system may allow the worker to move between visual screen displays by a spoken command such as ‘got it’ or ‘back up’. Workflow navigation module 110 may allow the worker to move between visual screen displays by tactile interaction with the user device.

In some embodiments, workflow navigation module 110 may, in the absence of any interaction by the worker, proceed to a conclusion. There may be a timeout period attached to each visual screen. At the conclusion of the timeout period, the tutorial system may move to the next screen in a fixed sequence. Workflow navigation module may, e.g. in accordance with display rules 120, permit the worker to skip the remainder of the tutorial, which the worker may activate via a spoken command and/or a tactile interaction with the mobile terminal.

Workflow navigation module 110 may also be coupled to a worker database 170, which may contain information relating to individual workers, or groups or categories of workers, who will experience the tutorial. Worker information stored in worker database 170 may personalize the worker's experience of tutorial elements 130. Worker information may include preferences related to language, font size, and audio volume. Worker information may include the worker's name or preferred nickname. Other worker preferences may also be stored, and default values may be used when preferences are unknown. Worker database 170 may also store worker information relating to the worker's previous interaction with tutorial elements 130. Information relating to the worker's previous interaction with tutorial elements 130 may inform display rules 120 to determine whether, and/or which, tutorial elements 130 will display when the particular worker logs in to the system.

The workflow navigation module 110 may also ask the user questions before starting up, and use the answers to those questions to choose preferences such as language, font size, and audio volume. In some cases the answers to those questions may determine the set of tutorial screens the user will see. In some cases, the answers to those questions may determine the timeout period between screens.

Turning now to FIG. 2, navigation between elements of the tutorial, by a worker 200 is shown. Worker 200 may be engaged with the tutorial, which comprises a first tutorial element 210 and a second tutorial element 220, which may be part of tutorial elements 130 of FIG. 1. The tutorial elements 130 follow a specific, predetermined sequence, as set forth by the administrator using workflow creation module 100.

Worker 200 may navigate from element 210 to the next element in the sequence 220, by means of a ‘forward command’ 230. The forward command 230 is a user input from worker 200 to signal to the system to move to the next tutorial element. In one example this may be a voice command, such as “got it.” In another example this may be through tactile interaction with the display screen, such as by pressing or clicking on a hardware button or a software button. In yet another example, this may be by scanning a barcode. Alternatively, the tutorial may progress from one element 210 to the next element in the sequence 220 via a timeout implemented by the workflow navigation module 110 if the worker takes no action. Such a timeout may be specified in display rules 120.

Worker 200 may also wish to move backwards in the tutorial, e.g. from element 220 to the previous element in the sequence 210, by means of a ‘back command’ 240. The back command 240 may be implemented as user input by the worker to signal the system to return to the previous tutorial element. In one example this may be a voice command such as ‘back up’. In another example this may be through tactile interaction with the display screen, such as by pressing or clicking on a hardware button or a software button. In yet another example, this may be by scanning a barcode.

Worker 200 may skip the remainder of the tutorial if allowed to do so by the display rules 120 set in the workflow creation module 100. Worker 200 may activate skipping the tutorial by means of a ‘skip command’ 250. Skip command 250 is a user input for worker 200 to signal the system to navigate directly to the conclusion 260 of the tutorial. In one example, this may be a voice command such as ‘skip training’. In another example, this may be through tactile interaction with the display screen, such as by pressing or clicking a hardware button or a software button. In yet another example, this may be by scanning a barcode. The conclusion 260 may be a final tutorial element that is last in the sequence, a special tutorial element that is presented to the worker when the skip command is uses, or purely an abstract element (that is, the worker will be presented directly with the next stage of the workflow beyond the tutorial).

If navigation of the tutorial by the worker involves voice commands, for example, ‘got it’, ‘back up’, ‘skip training’ or any other spoken phrases, workflow navigation module 110 may also allow the worker to request an enumeration of the available voice commands at that point in the tutorial. The enumeration of the available voice commands may be spoken to the worker via audio output 150, or may be shown on the visual display 140.

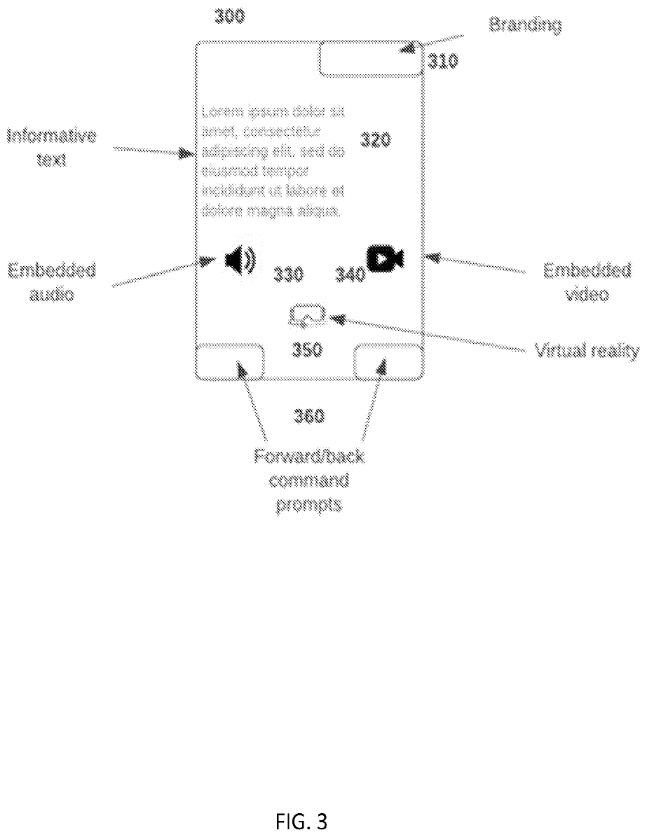

Turning now to FIG. 3, an exemplary user interface of tutorial element 300, as seen by worker 200, is shown. Tutorial elements may contain some or all of the components illustrated in FIG. 3, as described below.

Tutorial element 300 may contain branding 310 representing the organization that developed the tutorial and/or the organization that uses the tutorial. Tutorial element 300 may also contain informative text 320, which may in some embodiments be written in the worker's language of choice and intended for a visual display, related to some aspect of the workflow that the worker needs to learn. One example of informative text 320 would be a set of instructions, with or without visual aids, to aid the worker in physically positioning a headset and microphone for best effect. Another example of informative text 320 would be a set of instructions, with or without visual aids, for usage of a barcode scanner or other peripheral equipment. Yet another example of informative text 320 would be a set of instructions, with or without visual aids, for speaking of alphanumeric sequences of characters for optimal speech recognition performance. Yet another example of informative text 320 would be a high-level overview of the workflow the worker will be required to execute, with or without visual aids. Yet another example of informative text 320 would be a list of voice commands that the worker may use at critical points in the workflow the worker will be required to execute. Persons having skill in the art will realize that these examples are intended to be illustrative and not to limit the uses of informative text 320.

Tutorial element 300 may also contain embedded audio 330, embedded video 340, and/or virtual reality displays and experiences 350 to help illustrate to the worker some aspect of the workflow that they need to learn. One example of embedded audio 330 would be a sample dialog for a critical point in the workflow, playing the system prompts and the responses of a worker. One example of embedded video 340 would be a video demonstration of safety features of a piece of heavy equipment which the worker may use in the course of the workflow they will be required to execute. Virtual reality content may be activated by pressing or clicking a button on a main display to activate virtual reality in a virtual reality display. One example of a virtual reality display 350 would be a simulated warehouse environment where the worker views the proper execution of a workflow in the virtual reality. Persons having skill in the art will realize that these examples are intended to be illustrative and not to limit the uses of embedded audio 330, embedded video 340, and virtual reality 350 available in this invention.

Embedded audio 330, embedded video 340, or an embedded virtual reality experience 350 may auto-play when the worker reaches the appropriate point in the tutorial, in accordance with the manner in which the tutorial element was created. When the embedded audio 330, embedded video 340, or an embedded virtual reality experience 350 completes, the worker may choose, e.g. via user input, to replay the audio, video, or virtual reality experience. The system may, e.g. in accordance with a display rule 120, permit the worker to replay the embedded audio 330, embedded video 340 or embedded virtual reality experience 350 using one or more modalities. In one example of a worker requesting replay from the system, the worker may speak a voice command such as ‘replay’. In another example of a worker requesting replay from the system, the worker may press or click a hardware button or a software button on the mobile terminal. In yet another example of a worker requesting replay from the system, the worker may scan a barcode on the screen or posted separately.

In some embodiments, the screens may include dynamic content, which may include content personalized for the user. Dynamic content may include content that reflects language preferences of a user, the user's name, or nickname. Dynamic content may also include varying levels of descriptiveness, which may be chosen based on factors personal to the user, including the user's past productivity ratings.

A tutorial element 300 may contain navigation aids 360 to remind the worker of the options for navigation through the tutorial. One example of navigation aids 360 would be text boxes containing the phrases the worker must say to execute the forward command 230 and the back command 240. Another example of navigation aids 360 would be action buttons the worker may press to execute the forward command 230 and the back command 240. Yet another example of navigation aids 360 would be barcodes on the screen or posted separately, which the worker may scan with a peripheral barcode scanner to execute the forward command 230 and the back command 240.

A system, in accordance with an embodiment of the present disclosure, may include a device that is used by a worker who may be shown or otherwise receive training materials, e.g. at the same time the user is performing tasks. This device may include an application for displaying interactive content, which may be referred to herein as a “Quick Start App” or “QSA.” The Quick Start App may include an autonomous module that monitors host workflow activity for all users and sessions, and assesses, e.g. periodically or continually, whether to propose a set of QSA screens for any user of the host workflow to view at any particular time.

The Quick Start App can be set up by an admin user, e.g. a supervisor, who may use a tool which may be referred to as a Quick Start App Studio or QSAS.

Set up involves creating and saving individual tutorial elements and tutorial element sets (groups of tutorial elements in a defined order). Optionally, the QSAS user may also use the tool to define rules for tutorial element set display. (A tutorial element set may be displayed unconditionally at login. This does not require that any rules be defined.)

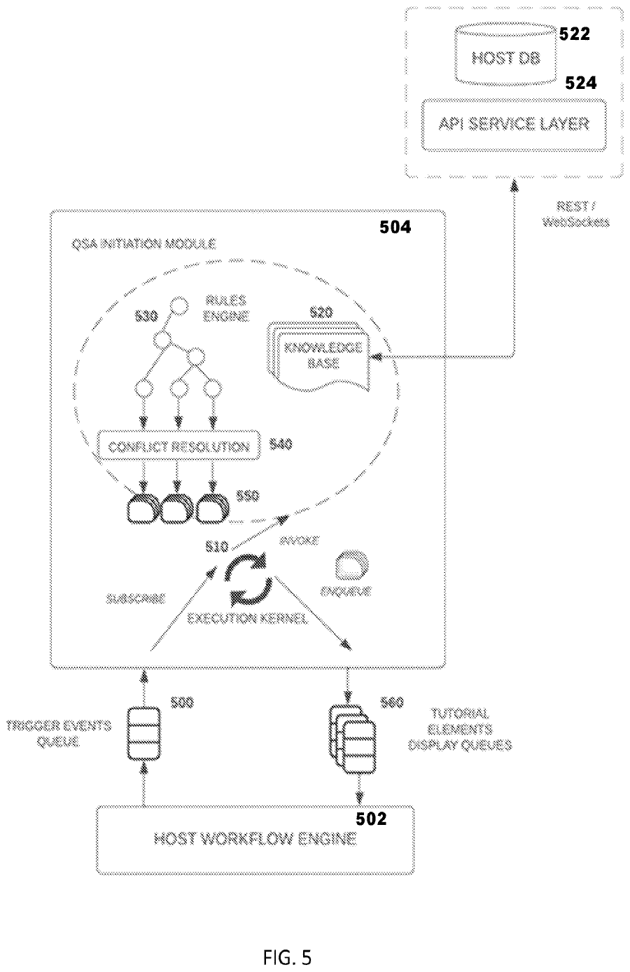

The QSAS user will have the means to save a tutorial element, tutorial element set, or rule when conditions are satisfied. The process of saving any of those entities will store a representation of that entity in a place and manner such that the representation will be available to various other modules of the system, including, the QSA Initiation Module (QIM 504), as discussed below with reference to FIG. 5, for purposes of evaluation and recommendation. The representation may also be available to the host workflow engine, for purposes of display. The representation may also be available to The QSAS itself in current and future sessions for this user or any other, for purposes of editing.

Tutorial elements, element sets, and rules may be stored in a storage medium, which may include a local file system, a cloud-based file system, a relational database, a document-based database, or any other system that provides access as described herein.

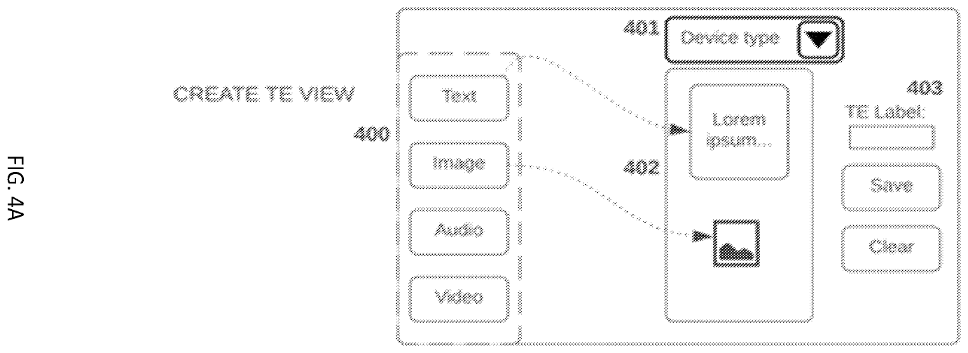

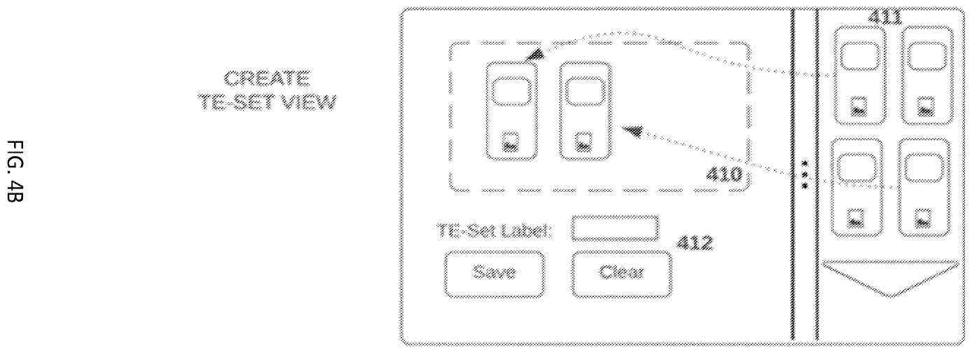

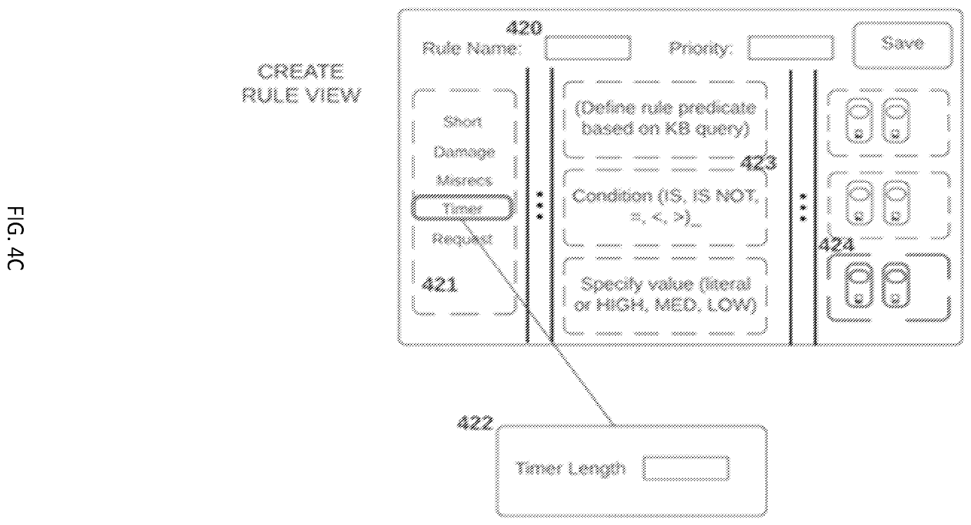

FIGS. 4A through 4C are exemplary set of user interface elements, illustrating the explanation of a logistics workflow to a user about to being executing assignments in that workflow, in accordance with one aspect of the present disclosure. Turning now to FIG. 4A, an exemplary user interface of a Create Tutorial Element (“TE”) View of a QSAS is shown. Create TE View allows the user to create and edit new tutorial elements. The user may also remove or delete tutorial elements from this view. The QSAS may be configured to allow or disallow the user changing or deleting any canned tutorial elements that may be provided with the product.

This view allows the user to select different modalities 400 that may make up a tutorial element. These modalities 400 may include rich text, images, audio, video, or (not shown) virtual reality experiences and other interactions. The user may select a modality 400 to add by dragging it onto the device canvas 402.

The Quick Start App may create tutorial elements for several different categories and form factors of mobile computing devices, and for several devices specifically, where tutorial elements may be viewed and interacted with. These categories may include smartphones, tablets, wrist mounted devices, or others.

Device type selection 401 allows the user to design the same or different tutorial elements for these different form factors. For example, an element that conveys certain specific information in words, pictures, and video on a tablet may use video only on a wrist-mount device.

Device type selection 401 attempts to convert a tutorial element created for one form factor, to another form factor cleanly, so that the display remains clear. If this is impossible, or if the conversion is determined not to be suitable to the second form factor, the user has the opportunity to design the element differently for the other device type.

Device canvas 402 gives the user a realistic sense of what the tutorial element under construction will look like on the device type. The user may size and place the visible tutorial elements for best effect. When the user drags a text component onto the canvas, a text editor appears to allow the user to enter and format the text he or she wishes, subject to the size constraints of the device type and component.

When the user drags an image or video component onto the canvas, it starts at a standard size based on the device type. The user may resize or move the component. The image or video is selected using a file chooser that will pop up when the component is placed on the canvas. The choice of image or video file is subject to file size (in terms of bytes) constraints. When the user drags an audio component onto the canvas, audio is selected using a file chooser that will pop up when the component is placed on the canvas. The choice of audio file is subject to file size (in terms of bytes) constraints.

There is a default delay for any tutorial element before any embedded audio or video starts to play. The user may customize the delay in a settings pane per component in this view. The user may also drag as many text and image components as can fit on the screen, but only one audio or video component per screen is allowed.

Create TE View may include TE View Controls 403. The user may save or clear a tutorial element in progress. A clear command will clear the canvas and start with an empty slate. A save command will persist the current element using any of a number of stores described in the Overview. Saving a tutorial element will tag that element with a unique ID for system use. The user may also provide a text label for the tutorial element. The element will be tagged with this label in the TE-Set view and in the ‘Open’ dialog for this view.

Turning now to FIG. 4B, where a Create TE-Set View is shown. This view allows the user to combine tutorial elements into ordered tutorial element sets, groupings that the system understands and will display together in the given order.

Using TE-Set Canvas 410, the user can place and order individual tutorial elements, creating a set that is intended to be displayed together and in a chosen order. Tutorial elements, which are created in device canvas 402 as described with reference to FIG. 4A, may be dragged into slots in set canvas 410 from tutorial element selection pane 411. The user can reorder tutorial sets in this pane as well.

The user can select any valid tutorial element using TE Selection 420, by the text label and a miniature view, and drag it to the canvas to add it to a set in any slot.

The user may use TE-Set View Controls 412 to save or clear a tutorial element set in progress. A clear command will clear the canvas and start with an empty slate. A save command will persist the current element set using any of a number of stores described in the Overview. Saving a tutorial element set will tag that set with a unique ID for system use. The user may also provide a text label for the tutorial element set. The element will be tagged with this label in the Create Rules view and in the ‘Open’ dialog for this view.

Turning now to FIG. 4C, where a Create Rule View is shown. This view allows the user to set up and edit display rules for tutorial element sets. The user may also remove/delete rules.

The user may use Create Rule View Controls 420 to save a completed rule, where all elements (trigger event, rule conditional, tutorial element set to display) are present in the view. The user may also give the rule a textual name, by which he or she may also be able to open and edit the rule in this view later. The user may also set a priority for the rule, relative to other rules that may conflict with it in the execution of the rules engine in QIM 504, as discussed below.

When the rule is created and saved, it is stored in a representation. A rule may be saved as Generated software code, in a compiled or interpreted language. A rule may also be saved as a configuration file entry, to be read by a software interpreter. A rule may also be saved as a table entry or set of table entries in a relational database. A rule may also be saved as a document or set of documents in a document-based database. A rule may also be saved as a set of nodes in a graph database. Other logical representations may also be used.

With trigger event selection 421, the user is presented with a list of all valid trigger events that have been configured for this application. The user may select the trigger event that will cause the rules engine to evaluate this rule for possible execution. Some examples of valid trigger events, for a warehouse setting, may include exception events occurring within a workflow, such as a short pick in a picking workflow or damaged goods in a receiving workflow; an excessive rate of misrecognitions, if the workflow is voice-enabled; the expiration of a timer, or a request by a user for assistance.

Some trigger events may react to or require context. For example, as shown, a trigger event based on the expiration of a timer 422 should specify how long the timer is. Other contextual display elements may be used in addition to or in lieu of timer 422. Another example may involve triggering a rule based on ‘excessive’ misrecognitions. The context window may let the user specify what misrecognition rate is ‘excessive’.

In rule definition pane 423, the controls on the screen may allow a user to specify the rule that will execute on the trigger event selected to the left. This is the ‘IF’ part of an ‘IF-THEN’ rule. There are three sub-panes here where the user may specify an entity, a condition, and a value. In the top pane, the user may specify an entity in the knowledge base. This may, for example, include user attributes or user history, where “user” in this context refers to the workflow user who will see the displayed QSA tutorial, rather than the user of the QSAS). This may also include application attributes.

In some embodiments, a rule can be created wherein a specific identified user, and/or a class of users, may be sent a set of training materials a second time, for repetition. This rule may be triggered by the same user having recently gone through the same materials. A rule may also be created wherein a user is sent a set of training materials based on the user having logged into a specific workflow less than a minimum number of times. For example, if the present login is the user's first, or the user's first, second or third, etc., the user may be sent training materials related to that workflow.

The condition part of the rule defines the comparison of the entity with the value. In this pane, the user will have a choice of logical conditions such as IS, IS NOT, ==, !=, <, <=, > or >=. Other conditional comparisons may also be used. The value specified may be, depending on the entity, a literal value or a calculated comparison (HIGH, MODERATE, LOW). The system will determine which values are HIGH, MODERATE or LOW using internal algorithms.

As an example, rules may be contingent upon productivity, which may be implemented using productivity thresholds, such as low, medium, or high productivity. Percentiles of productivity could also be used. For example, if a user is in the bottom 10 percentile of productivity over the past 48 hours, the system can define that as “low.” Other comparisons or benchmarks could also be used. Rules can be made to fire based on the user's productivity over a period of time.

In TE-set selection pane 424, the user selects a tutorial element set to display when the rule defined in the center pane is satisfied in response to an occurrence of the trigger event selected in the left pane. These tutorial elements may be individual elements as created in FIG. 4A, or element sets as created in FIG. 4B. Tutorial element sets are shown in a scrollable list and identifiable by the text label given when the element set is created in the ‘Create TE Set View’ as shown in FIG. 4B.

Turning now to FIG. 5, a system diagram of a Quick Start App Initiation Module, or QIM 504, is shown. At runtime, the module that determines whether to propose a set of QSA screens may be referred to herein as a “QSA Initiation Module” or “QIM 504.” The QSA screens may be delivered to a user device, which may include, as discussed above, a smartphone, a watch, a tablet, and/or a virtual reality and/or augmented reality headset, or the like.

QIM 504 may run an execution kernel as its main loop. Execution kernel 510 is in communication, e.g. constantly, with host workflow engine 502, which is the system that the QSA is intended to give its users a ‘Quick Start’ on. As discussed in more detail below, workflow engine 502 provides a steady stream of events to QIM 504. QIM 504 reviews these events in the context of its knowledge about the users and applications, and sometimes it recommends a set of tutorial elements for display by the QSA. Once given the tutorial element set, the workflow invokes the QSA to display those elements at the appropriate time. It may be preferable that QIM 504 not arbitrarily interrupt the user's progress through the workflow with QSA content.

QIM 504's communication with the host workflow is asynchronous, using the concept of message queues, which may also be known as software mailboxes. After providing an event to QIM 504, which may or may not result in a QSA recommendation, the host workflow need not pause execution waiting for a reply.

Some examples discussed herein may relate to the user being a worker in a warehouse, and references may be made to specific workflow relating to a warehouse setting. Persons having skill in the art will realize that other work environments may also be enhanced by the systems and methods of the present disclosure.

Trigger events queue 500 may receive a stream of events from host workflow engine 502 and may provide provides a stream of such events to QIM 504. Events in trigger events queue 500 may ‘trigger’ a rules engine 530 of QIM 504 to run, and may also trigger a recommendation of a set of tutorial elements to display. Events that may be stored and/or presented via trigger events queue 500 may include failure of the workflow user to achieve voice recognition in a voice-driven workflow, absence of product to be picked, in a logistics picking workflow, damaged product on the receiving line, in a logistics receiving workflow, commencement of a task that may be unduly complicated or require special instructions, or specific requests for troubleshooting help by a workflow user. The events listed are exemplary, and other events may also be used as trigger events.

Trigger events queue 500 temporarily stores events in an object-based format. The object based format may contain different classes of data, which may include a unique key for each event, an identifier of the user/session that triggered the event, an event category understood by both workflow engine 502 and QIM 504, event-specific data, or a timeout for time sensitive events. Other classes of data may also be stored in an event object.

A single queue, for all trigger events, may be used. A managed set of queues which separate events by one or more criteria such as: user/session, event category, date/time, etc., may also be used.

Trigger events queue 500 is asynchronous. Accordingly, when host workflow engine 502 enqueues an event into trigger events queue 500, workflow engine 502 is notified whether or not the enqueue was successful, but may not be notified immediately regarding what, if any, tutorial element set is recommended as a result of the event. Trigger events queue 500 may be implemented specifically to any host, in any programming language or framework. Alternatively, trigger events queue 500 may be a third party message queue product incorporated into the system.

The software element that manages trigger events queue 500 may also honor timeout settings for events and may also provide monitoring, logging and operational notifications. Operational notifications may include notifications if the queue grows beyond a certain threshold.

As shown in FIG. 5, execution kernel 510 runs in a main loop in a main computing thread. In a continual cycle, execution kernel 510 subscribes to events from trigger event queue 500, invokes rules engine 530 to determine whether to recommend a tutorial element set, and enqueues the recommended elements to be read by host workflow engine 502.

Execution kernel 510 may poll trigger events queue 500 at configurable intervals, or it may use a publish/subscribe model to receive notifications when an event is added to the queue 500. Either way, the event is delivered to execution kernel 510 in an object-based format, containing information as set forth above.

Another internal event that may trigger a run of rules engine 530 is the passage of time. QIM 504 may implement internal timers whose expiration may cause rules engine 530 to run and recommend a tutorial element set for one or more users. Such a recommendation may be based on a variety of environmental factors, which may include changes in knowledge base 520.

Execution kernel 510 may be configured to parse event information, temporarily store event objects, and discard duplicate events. Execution kernel 510 may also log and provide operational notifications of anomalies such as excessive event storage.

Execution kernel 510 invokes rules engine 530 with the salient event information. It may do so on its main computing thread, or it may dedicate a processing thread to each invocation of rules engine 530.

Execution kernel 510 may also select an outbound tutorial elements display queue 560 corresponding to the user and/or session in the original trigger event information, to provide a return value from rules engine 530. Rules engine 530 may return an empty set, in which case, execution kernel 510 will not attempt to enqueue the return value.

Execution kernel 510 may also append each event, together with the decision of rules engine 530, to a log for auditability. This log may be maintained in the filesystem or in a database or other data store, either internal or external to the machine on which execution kernel 510 runs.

The corpus of facts that rules engine 530 uses to determine which, if any, rules to fire in any given evaluation cycle, may be contained in knowledge base 520, which may also be referred to as a fact base. Knowledge base 520 may be implemented in a variety of ways, some known in the art, such as directly embedded into the nodes of rules engine 530, as a set of objects internal to application memory, or in a graph format (e.g. as a set of nodes and connections) in application memory. Knowledge base 520 may also be implemented as an in-memory database either custom-built or third-party, as an external relational database, or as an external document-based database. Other implementations may also be used. The implementation may be chosen based on performance and reliability needs for the given system as a whole. Knowledge base 520, in any of these implementations, may be indexed for superior performance.

Knowledge base 520 may either be integrated with, or queryable by, rules engine 530. Knowledge base 520 may be updated directly by rules engine 530, as a result of the output of one or more rules. Any such updates may be incidental to the selection of a set of tutorial elements in response to a trigger event.

Knowledge base 520 will take regular updates from host database 522 via a host API service 524. This may be the same database that underpins host workflow engine 502, or it may be a separate database for the purpose of informing QIM 504.

Knowledge base 520 may have an application thread that polls one or more Application Programming Interfaces (“APIs”) published by a host API service 524. Alternatively, if supported by host API service 524, knowledge base 520 may maintain one or more open connections to host API service 524 on one or more application threads. On these connections, knowledge base 520 may subscribe to push notifications when there are changes to the data elements in the data source behind the APIs.

Knowledge base 520 maintains information relevant to the presentation of training modules in accordance with rules. Information that may be stored in the knowledge base could include static objects representing users, applications, and other entities such as warehouses and zones, dynamic user productivity information, user history information in detail and summary, or histories of users' interactions with the QSA itself. Other information may also be stored in knowledge base 520.

Knowledge base 520 may also contain executable functions for summarizing information. For instance, knowledge base 520 can assess the extent of a user's experience with a particular workflow application, or with a particular condition in a workflow application. Knowledge base 520 can also assess the recency of that user's experience with a workflow application or a condition. Knowledge base 520 can therefore classify, for example, a user's experience with some aspect of a certain workflow as ‘LOW’, ‘MODERATE’ or ‘HIGH’, and provide that experience as a ‘fact’ upon which rules engine 530 may act.

Rules engine 530 combines the occurrence of an event, e.g. from trigger events queue 500, with the corpus of facts in knowledge base 520 to recommend a response to that event, e.g. a set of tutorial elements.

The rules may be pre-defined by an ‘expert’ stakeholder. As discussed below, procedures described herein may be used to create or modify rules. Rules may be defined and loaded by the end customer, by a separate consultant, or by a solution developer with programming experience and skill.

The general form of a rule is:
IF <conditions>
THEN <actions>

‘Conditions’ may be compound, connected by Boolean operators such as AND or OR clauses.

‘Actions’ will usually involve the definition of a set of tutorial elements to display. They may involve other changes such as updates to knowledge base 520.

Alternative implementations of rules engine 530 include the following, and the QIM 504 rules engine may combine one or more of these implementations. Alternative implementations may include a series of ‘IF-THEN’ programming statements in one or more software functions, a set of predicate functions (conditions) and consequent functions (actions) in software code, a graph construct with nodes representing rules and facts, a machine learning model or neural network, or a third-party rules engine.

A given implementation of QIM 504 may load rules dynamically into the system from configuration files or as the output of a domain-specific language (DSL) provided to an administrator in a user interface. A given implementation of QIM 504 may alternatively require that rules be loaded into the system only as part of a software build.

Rules engine 530 will return to execution kernel 510 a set of tutorial elements recommended for display. The return value from rules engine 530 may take the form of the code or data for the specific tutorial elements. For example, rules engine 530 may return an HTML object or an audio stream. Alternatively, rules engine 530 may return references to copies of these artifacts stored in system memory, in the filesystem, or in an external database or other data store.

Rules engine 530 may return an empty set of tutorial elements. This is a valid return and means that the engine does not recommend any tutorial element display at this time.

As part of its rules engine, QIM 504 contains a conflict resolution module 540, which may contain a strategy or set of strategies for resolving conflict between rules. A given set of facts and trigger event may cause multiple rules to fire, which could lead to competing recommendations of tutorial element sets 550. QIM 504 will not load multiple sets of tutorial elements into any session's display queue, and, so, conflicts between rules that are both set to fire under certain conditions, may require resolution.

In some embodiments, conflicts may be resolved using a priority value. An object representation of any rule in the system may optionally contain a priority value which can be used as a guide in the event of conflicts with other rules.

QIM 504 also has the notion of ‘stronger’ and ‘weaker’ conditions. For example, a condition related to how recently a given user has viewed a given tutorial element set is a stronger condition because QIM 504 ‘wants’ to avoid showing the same tutorial element sets 550 often. A condition related to a user's productivity assessment as LOW, MODERATE or HIGH would be a weaker condition, compared to others, because this measurement is more subjective. QIM 504's conflict resolution logic 540 favors tutorial element sets 550 recommended by rules operating on stronger conditions.

QIM 504's conflict resolution 540 may also include software-based decision trees as a second stage of processing where only the tutorial element sets 550 in ‘conflict’ are considered.

Rules engine 530 is generally built to emit one of a pre-defined collection of tutorial element sets 550. Some tutorial elements may be represented in different sets, in the same or a different order.

Rules engine 530 may contain rules that remove or insert specific tutorial elements from pre-defined sets before emitting the set as the decision outcome. Rules engine 530 emits tutorial element sets 550 as ordered lists of individual tutorial elements.

The tutorial element sets 550 emitted by rules engine 530 may take the form of the code or data for the specific tutorial elements. For example, rules engine 530 may return artifacts such as an HTML object or an audio or video stream. Alternatively, rules engine 530 may return references to copies of these artifacts stored in system memory, in the filesystem, in an external database or other data store.

Tutorial element sets 550 are presented back to host workflow engine 502 for display via QSA, by placing the element sets into one of a set of message queues 560.

Each node in the queue 560 may store the artifacts representing the tutorial element sets 550. For example, they may directly store HTML code, audio streams, video streams, or artifacts representing any other modality 400 supported by the QSA.

Alternatively, each node in the queue may store references to the artifacts representing the tutorial element sets 550. Artifacts may be stored in a commonly accessible data store such as a filesystem, a separate in-memory database accessible by a software API, an external relational database, or an external document-based database. External data stores may be local to the machine where QIM 504 and host workflow engine 502 are running, elsewhere in a local network, or in the cloud.

In addition to the tutorial element sets 550, each queue entry stores meta-information, including the user/session that the set is intended for, and timestamp information.

There is at least one queue for every user/session active on host workflow engine 502. There may also be a mechanism for host workflow engine 502 to request of QIM 504 that a certain queue be created or destroyed. QIM 504 may also contain logic for destroying queues based on periods of inactivity, and contains a facility for logging and monitoring the queues, and for sending operational notifications of inactive queues and other failure indicators.

“One queue for every user/session” may be implemented as separate message queues, or as a single queue, partitioned by a key that identifies the user/session. Each message queue may store one and only one set of tutorial elements at a given time. A tutorial element set added by QIM 504 may replace a set already on the queue.

The tutorial elements display queues 560 are asynchronous, meaning that when QIM 504 enqueues a tutorial set, the return value of the operation only refers to whether or not the set was successfully enqueued. Host workflow engine 502 may poll the tutorial elements display queues 560 in the individual user/session threads, or register handler code to be called as a notification when there is a change to the queues.

Tutorial elements display queue 560 may be implemented specifically to any host, in any programming language or framework. Alternatively, the tutorial elements display queue 560 may be a third party message queue product incorporated into the system.

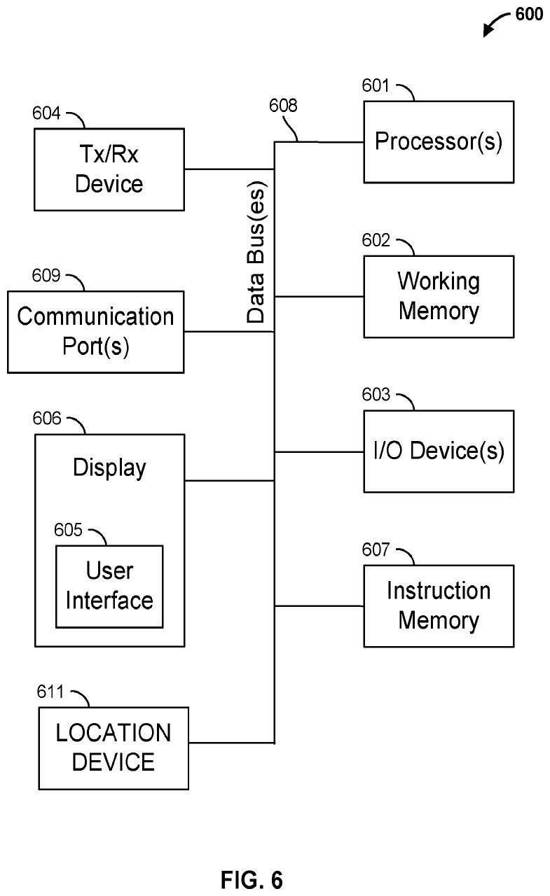

FIG. 6 illustrates a block diagram of a workflow tutorial device 600, e.g. a device in the system in FIG. 1, in accordance with some embodiments of the present teaching. In some embodiments, each of the devices and systems in FIGS. 1-5 may include the features shown in FIG. 6. Although FIG. 6 is described with respect to certain components shown therein, it will be appreciated that the elements of the workflow tutorial device 600 can be combined, omitted, and/or replicated. In addition, it will be appreciated that additional elements other than those illustrated in FIG. 6 can be added to the workflow tutorial device 600.

As shown in FIG. 6, the workflow tutorial device 600 can include one or more processors 601, an instruction memory 607, a working memory 602, one or more input/output devices 603, one or more communication ports 609, a transceiver 604, a display 606 with a user interface 605, and an optional location device 611, all operatively coupled to one or more data buses 608. The data buses 608 allow for communication among the various components. The data buses 608 can include wired, or wireless, communication channels.

The one or more processors 601 can include any processing circuitry operable to control operations of the workflow tutorial device 600. In some embodiments, the one or more processors 601 include one or more distinct processors, each having one or more cores (e.g., processing circuits). Each of the distinct processors can have the same or different structure. The one or more processors 601 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 601 may also be implemented by a controller, a microcontroller, an application specific integrated circuit (ASIC), a field programmable gate array (FPGA), a programmable logic device (PLD), etc.

In some embodiments, the one or more processors 601 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 607 can store instructions that can be accessed (e.g., read) and executed by at least one of the one or more processors 601. For example, the instruction memory 607 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 601 can be configured to perform a certain function or operation by executing code, stored on the instruction memory 607, embodying the function or operation. For example, the one or more processors 601 can be configured to execute code stored in the instruction memory 607 to perform one or more of any function, method, or operation disclosed herein.

Additionally, the one or more processors 601 can store data to, and read data from, the working memory 602. For example, the one or more processors 601 can store a working set of instructions to the working memory 602, such as instructions loaded from the instruction memory 607. The one or more processors 601 can also use the working memory 602 to store dynamic data created during one or more operations. The working memory 602 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 607 and working memory 602, it will be appreciated that the workflow tutorial device 600 can include a single memory unit configured to operate as both instruction memory and working memory. Further, although embodiments are discussed herein including non-volatile memory, it will be appreciated that the workflow tutorial device 600 can include volatile memory components in addition to at least one non-volatile memory component.

In some embodiments, the instruction memory 607 and/or the working memory 602 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, Javascript, C, C++, C #, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 601.

The input-output devices 603 can include any suitable device that allows for data input or output. For example, the input-output devices 603 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 604 and/or the communication port(s) 609 allow for communication with a network. In some embodiments, the transceiver 604 is selected based on the type of the communication network the workflow tutorial device 600 will be operating in. The one or more processors 601 are operable to receive data from, or send data to, a network via the transceiver 604.

The communication port(s) 609 may include any suitable hardware, software, and/or combination of hardware and software that is capable of coupling the workflow tutorial device 600 to one or more networks and/or additional devices. The communication port(s) 609 can be arranged to operate with any suitable technique for controlling information signals using a desired set of communications protocols, services, or operating procedures. The communication port(s) 609 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 609 allows for the programming of executable instructions in the instruction memory 607. In some embodiments, the communication port(s) 609 allow for the transfer (e.g., uploading or downloading) of data, such as machine learning model training data.

In some embodiments, the communication port(s) 609 are configured to couple the workflow tutorial device 600 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 604 and/or the communication port(s) 609 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 606 can be any suitable display, and may display the user interface 605. For example, the user interfaces 605 can enable user interaction with the workflow tutorial device 600. For example, the user interface 605 can be a user interface for an application of a network environment operator that allows a customer to view and interact with the operator's website. In some embodiments, a user can interact with the user interface 605 by engaging the input-output devices 603. In some embodiments, the display 606 can be a touchscreen, where the user interface 605 is displayed on the touchscreen.

The display 606 can include a screen such as, for example, a Liquid Crystal Display (LCD) screen, a light-emitting diode (LED) screen, an organic LED (OLED) screen, a movable display, a projection, etc. In some embodiments, the display 606 can include a coder/decoder, also known as Codecs, to convert digital media data into analog signals. For example, the visual peripheral output device can include video Codecs, audio Codecs, or any other suitable type of Codec.

The optional location device 611 may be communicatively coupled to a location network and operable to receive position data from the location network. For example, in some embodiments, the location device 611 includes a GPS device configured to receive position data identifying a latitude and longitude from one or more satellites of a GPS constellation. As another example, in some embodiments, the location device 611 is a cellular device configured to receive location data from one or more localized cellular towers. Based on the position data, the workflow tutorial device 600 may determine a local geographical area (e.g., town, city, state, etc.) of its position.

In some embodiments, the workflow tutorial device 600 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques.

Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

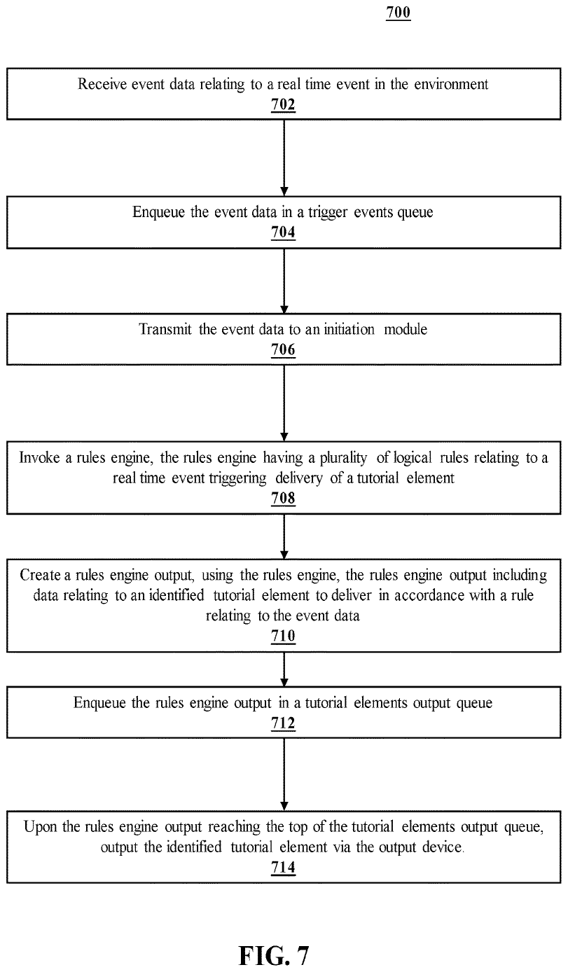

FIG. 7 is a flow chart illustrating an exemplary method 700 for delivering tutorial elements to a user in response to real time events in an environment of the user, in accordance with an embodiment of the present disclosure.

Event data relating to a real time event in the environment may first be received (702). Event data may then be enqueued (704) in a trigger events queue. Event data may then be transmitted (706) transmit to an initiation module. A rules engine may then be invoked (708). The rules engine may have a plurality of logical rules relating to a real time event triggering delivery of a tutorial element. The rules engine may then create (710) a rules engine output. The rules engine output may include data relating to an identified tutorial element to deliver in accordance with a rule relating to the event data. The rules engine output may then be enqueued (712) in a tutorial elements output queue. Upon the rules engine output reaching the top of the tutorial elements output queue, the identified tutorial element may then be output (714) via the output device.

The output device may be an audio output device, display, virtual reality device, or radio frequency scanning device. The rules engine output may be based on user data relating to the user of the apparatus at the time of the real time event. The user data may include user experience data relating to a level of experience of the user with respect to one of the event and the identified tutorial element. The real time event may be received by the apparatus via input from the user to an input device. The real time event may also be received via observation of the environment by the apparatus without direct input from the user. An augmented reality viewer may also be configured to observe the environment of the user to register events.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations are chosen in order to best explain the principles underlying the claims and their practical applications, to thereby enable others skilled in the art to best use the implementations with various modifications as are suited to the particular uses contemplated.

1. An apparatus for delivering tutorial elements to a user in response to real time events in an environment of the user, the apparatus comprising:
an output device;
a processor; and
a memory, the memory having stored thereon computer executable instructions which, when executed by the processor, cause the processor to:
receive event data relating to a real time event in the environment,
enqueue the event data in a trigger events queue,
transmit the event data to an initiation module,
invoke a rules engine, the rules engine having a plurality of logical rules relating to a real time event triggering delivery of a tutorial element,
create a rules engine output, using the rules engine, the rules engine output including data relating to an identified tutorial element to deliver in accordance with a rule relating to the event data,
enqueue the rules engine output in a tutorial elements output queue, and
upon the rules engine output reaching the top of the tutorial elements output queue, output the identified tutorial element via the output device.

2. The apparatus of claim 1, wherein the output device is at least one of: an audio output device, display, virtual reality device, or radio frequency scanning device.

3. The apparatus of claim 1, wherein the rules engine output is further based on user data relating to the user of the apparatus at the time of the real time event.

4. The apparatus of claim 3, wherein the user data includes user experience data relating to a level of experience of the user with respect to one of the real time event and the identified tutorial element.

5. The apparatus of claim 1, wherein the real time event is received by the apparatus via input from the user to an input device.

6. The apparatus of claim 1, wherein the real time event is received via observation of the environment by the apparatus without direct input from the user.

7. The apparatus of claim 6, further comprising an augmented reality viewer configured to observe the environment of the user to register events.

8. A system for use by a developer in developing tutorial elements for delivery to a user device in response to real time events measured by the user device, the system comprising:
a processor; and
a memory, the memory having stored thereon computer executable instructions which, when executed by the processor, cause the processor to:
generate and display a first user interface for creation and editing of a set of tutorial elements, wherein the tutorial elements include at least one of text, audio, and video,
generate and display a second user interface for designing a tutorial element for a class of user device form factor(s) chosen by the developer,
generate and display a third user interface for the developer to create a rule, the rule including logical conditions relating to the real time events to trigger delivery of the set of tutorial elements, and
store the rule and the tutorial element.

9. The system of claim 8, wherein the rule is based on user data relating to a user of the user device at the time of the real time events.

10. The system of claim 9, wherein the user data includes user experience data relating to a level of experience of the user with respect to one of the real time events and the tutorial element.

11. A method of delivering tutorial elements to a user in response to real time events in an environment of the user, comprising:
receiving event data relating to a real time event in the environment,
enqueueing the event data in a trigger events queue,
transmitting the event data to an initiation module,
invoking a rules engine, the rules engine having a plurality of logical rules relating to a real time event triggering delivery of a tutorial element,
creating a rules engine output, using the rules engine, the rules engine output including data relating to an identified tutorial element to deliver in accordance with a rule relating to the event data,
enqueueing the rules engine output in a tutorial elements output queue, and
upon the rules engine output reaching the top of the tutorial elements output queue, outputting the identified tutorial element via an output device.

12. The method of claim 11, wherein the output device is at least one of: an audio output device, display, virtual reality device, or radio frequency scanning device.

13. The method of claim 11, wherein the rules engine output is further based on user data relating to the user at the time of the real time event.

14. The method of claim 13, wherein the user data includes user experience data relating to a level of experience of the user with respect to one of the real time event and the identified tutorial element.

15. The method of claim 11, wherein the real time event is received via input from the user to an input device.

16. The method of claim 11, wherein the real time event is received via observation of the environment without direct input from the user.

17. The method of claim 16, further comprising an augmented reality viewer configured to observe the environment of the user to register events.
